(19) United States
(12) Patent Application Publication
(10) Pub. No.: US 2017/0306219 A1
(43) Pub. Date: Oct. 26, 2017

(54) CONTROLLED RELEASE OF CHEMICALS IN OILFIELD OPERATIONS

(71) Applicant: TRICAN WELL SERVICE LTD., Calgary (CA)

(72) Inventors: Harvey QUINTERO, Calgary (CA); Chuanzhong WANG, Calgary (CA); Kewei ZHANG, Calgary (CA); Bill O'NEIL, Calgary (CA); Weibing LU, Calgary (CA)

(73) Assignee: TRICAN WELL SERVICE LTD., Calgary (CA)

(21) Appl. No.: 15/493,879

(22) Filed: Apr. 21, 2017

Related U.S. Application Data
(60) Provisional application No. 62/326,642, filed on Apr. 22, 2016.

(51) Int. Cl. C09K 8/80; E21B 43/26; C09K 8/60; C09K 8/528; E21B 37/06; C09K 8/68; E21B 43/267; E21B 43/04

(52) U.S. Cl. CPC C09K 8/805; E21B 43/267; E21B 43/26; E21B 43/04; C09K 8/528; E21B 37/06; C09K 8/68; C09K 8/605; C09K 2208/20

(57) ABSTRACT

Particulates, such as proppants, that are coated with a coating agent selected from the group consisting of: organosilanes, organosiloxanes, polysiloxanes, long carbon chain hydrocarbon amines containing no silicon or fluoro-based groups in the molecule, amine functionalized polyolefins and polymerizable natural oils; and a chemical additive selected from the group consisting of: a scale inhibitor, a biocide, and an H₂S scavenger. The coating agent controls the release of the additive from the particulate surface into surrounding fluid, providing a slow release that promotes the long lasting effect of the additive. The coated particulates have use in oilfield applications such as hydraulic fracturing operations, gravel pack operations, and in water treatment processes.

### CROSS-REFERENCE TO RELATED APPLICATIONS

This application claims the benefit of U.S. provisional application 62/326,642, filed Apr. 22, 2016, the entirety of which is incorporated herein by reference.

### FIELD

Compositions and methods for different applications, particularly oilfield operations such as hydraulic fracturing. More particularly, this disclosure relates to the embedment or attachment of oilfield chemicals, such as scale inhibitors and biocides, to a particulate coating, to control their release into a surrounding fluid.

### BACKGROUND

Hydraulic fracturing is a technology commonly used to enhance oil and gas production from a subterranean formation. During this operation, a fracturing fluid is injected along a wellbore into a subterranean formation at a pressure sufficient to initiate fractures in the formation. Following fracture initiation, particulates, commonly known as proppants, are transported into the fractures as a slurry, that is, as a mixture of proppants suspended in fracturing fluid. At the last stage, fracturing fluid is flowed back to the surface leaving proppants in the fractures, forming proppant packs which prevent the fractures from closing after pressure is released. The proppant packs provide highly conductive channels through which hydrocarbons can effectively flow.

There are a number of different known proppants, including sands, ceramic particulates, bauxite particulates, glass spheres, resin coated sands, synthetic particulates and the like. Among them, sands are by far the most commonly used proppants. Proppants normally range in size between about 10 to about 100 U.S. mesh, which is about 2,000 to about 150 μm in diameter.

A vast majority of the fracturing fluids currently used are aqueous-based. Since proppants normally have a significantly higher density than water, for example the density of sand is typically about 2.6 g/cm³ while that of water is 1 g/cm³, a high viscosity fluid is required to prevent the proppants from settling out of the slurry. For this purpose, viscosifiers such as water-soluble polymers or viscoelastic surfactants are commonly added to the slurry to increase the fluid viscosity. A cross-linked fluid having guar gum cross-linked by borates is a well-known example of this technology in the fracturing industry. In comparison with a fluid having a cross-linked gel, fluids comprising linear gels, i.e., fluids containing enough polymer to significantly increase fluid viscosity without cross-linking, cause less formation damage and are more cost-effective, but they have relatively poor suspension capability compared to fluids having a cross-linked gel.

“Slick water” or simply “water” fracturing is a method of hydraulic fracturing that is widely used in fracturing shale or tight formations. In slick water fracturing, water containing a very small amount of friction reducing agent is pumped into a formation at high rates to generate narrow, complex fractures. Pumping rates must be sufficiently high to transport proppant over long distances, before entering the fracture. The fracturing fluid is pumped down the well-bore as fast as 100 bpm, as compared to conventional (non-slick water) fracturing, where the top speed of pumping is around 60 bpm. A friction-reducing agent is added in water to suppress turbulence at high pumping rates thus reducing pumping pressure. Polyacrylamide-based friction reducing agents, which include polyacrylamides and polyacrylamide copolymers (which contain other monomers in addition to acrylamide monomers), are predominantly used, in an amount between about 0.02 wt. % to about 0.05 wt. % of the fluid. Because of its low cost and its ability to create a complex fracture network leading to better production, slick water has recently become the “go-to” fluid for fracturing shale or tight formations.

After the well is put on production, crude oil and/or gas flows out of the well, often not as a single phase, but as a multi-phase flow, namely as a mixture of oil or gas and water. Further, crude oil itself is a complex mixture of different hydrocarbons ranging normally from butane to long chain paraffin wax, as well as asphaltene; while water is normally brine water comprising different amounts of inorganic ions including K⁺, Ca²⁺, Mg²⁺, Cl⁻, CO₃²⁻ and SO₄²⁻. During production, because of changes in temperature, pressure and other conditions, wax and asphaltene can precipitate out of oil forming organic scales, and carbonate salts, such as CaCO₃ or MgCO₃, or sulphate salts, such as CaSO₄ or MgSO₄, can precipitate out of water forming inorganic scales. The formation of scale, be it organic or inorganic, often occurs in both the subterranean formation and in the wellbore, and impedes production flow and worsens pipe corrosion.

To mitigate scale formation, it is common to add chemical inhibitors known as scale inhibitors directly into fracturing fluid during fracturing operations. Inhibitors used for preventing inorganic scale buildup include lignin amines, inorganic and organic polyphosphates, carboxylic acid copolymers, phosphinic polycarboxylate, polyepoxysuccinic acid, polyaspartates, sodium gluconate and sodium glucoheptonate. Inhibitors used for preventing wax scale formation include urea, fullerenes (aniline/& phenol), and those used for preventing asphaltene scale formation include alkyl aryl sulfonic acid, alkyl phenol, esters of polyacrylate, polymaleate, polyphosphoric acid, polycarboxylic acid, and N,N dialkylamides of fatty acid.

Another common problem during production is the growth of sulfate reducing bacteria (SRB), which causes well souring, i.e., an otherwise clean well starts to produce hydrogen sulfide (H₂S). SRB are a kind of bacteria that consume sulphates in the fluids and convert them to H₂S, which is a very toxic and pungent gas that causes problems in both upstream and downstream processes. SRB occur commonly in nature and can be introduced into a well by operational fluids, such as fracturing or drilling fluids, or they can pre-exist in formations and become activated by the operational disruption of the underground eco-environment. To combat the H₂S problem, a biocide or H₂S scavenger is added to the fracturing fluid that is pumped into the formation.

Since a production well can last for decades and the formation of scale or H₂S is a gradual process that accompanies its entire life cycle, it is highly desirable to keep the scale inhibitors, biocides and H₂S scavengers active in a formation for as long as possible. Unfortunately, most of these compounds will flow back with the fracturing fluid, after the fracturing treatment. To prolong the effectiveness of these types of additives, a few technologies have been developed. For example, the additives have been impregnated into pores of specially engineered ceramic proppants, as described in U.S. Pat. No. 5,964,291 (hereafter the '291 patent), or adsorbents have been used to adsorb the additives onto naturally occurring diatomaceous earth, such as clays, and then adding them into hydraulic fracturing fluid, as described in U.S. Pat. No. 7,493,955 (hereafter the '955 patent). One of the potential drawbacks of the '291 patent teaching is that ceramic proppants are very expensive compared to sand proppants and they only find limited applications in formations deeper than 4,000 meters, which excludes current shale formations. The teaching of '955 patent provides a versatile method for adsorbing different additives and releasing them slowly into formations to prolong their effectiveness. Its drawback is that adding extra small particles, such as clay, into the formation may reduce conductivity of the proppant pack, which is vital for well production.

Water storage tanks should be periodically disinfected, where chlorine and iodine are commonly used as disinfection agents or biocides. Large volumes of water from different sources including town water, creek water and produced water are commonly used in oilfield operations such as hydraulic fracturing and drilling. When water, including flowback water, is stored in a water tank over a prolonged period of time, a biocide such as chlorine has to be periodically added to the water to maintain a level of biocide appropriate to reduce bacteria growth (slime) in water. It is of interest to have a controlled release of biocide in water to prevent bacterial growth for a prolonged period of time. Alternatively, in water sand bed filtration for treating water from different sources including for drinking water and oilfield water, where normally different sized sands are packed into a sand column to capture different sized particulates, it is of interest to have sands or particulates that are capable of releasing biocide or scale inhibitors in a controlled manner.

There is a need for more efficient and cost effective compositions and methods for the controlled release of chemical additives which mitigate scale formation and bacteria-caused problems, and which may be used in different applications, including in water-treatment processes and in the oil and gas industry.

### DRAWINGS

FIG. 1: Inorganic scale inhibitor (PBTCA) percentage released profile, with and without amino-polysiloxane, tung oil and polyisobutylene amine coating.

FIG. 2: Biocide (THPS) percentage released profile, with and without amino-polysiloxane coating.

### SUMMARY

Embodiments herein are compositions and methods for attaching or embedding chemical additives to or within a surface coating layer on particulates so that they slowly leach out of or are released from the coating into surrounding fluid. This slow release promotes long lasting effects of the additive, and finds application in different oilfield operations including in hydraulic fracturing operations, and in water-treatment processes.

In one aspect, described herein is a method of hydraulic fracturing of a formation, comprising:

a) preparing a hydraulic fracturing fluid by mixing coated proppants with an aqueous liquid:

wherein the coated proppants are coated with:
i) a coating agent selected from the group consisting of: organosilanes, organosiloxanes, polysiloxanes, long carbon chain hydrocarbon amines containing no silicon or fluoro-based groups in the molecule, amine functionalized polyolefins and polymerizable natural oils; and
ii) an oilfield chemical additive selected from the group consisting of: a scale inhibitor, a biocide, and an H₂S scavenger; and

b) pumping the hydraulic fracturing fluid into the formation.

In a preferred embodiment the hydraulic fracturing fluid is a slick water fracturing fluid.

In one embodiment the method further comprises preparing the coated proppants by contacting uncoated proppants with a mixture of the coating agent and the oilfield chemical additive. In another embodiment the method further comprises preparing the coated proppants by contacting pre-treated proppants that have been coated with the coating agent, with the oilfield chemical additive.

In embodiments the contacting comprises spraying a liquid medium comprising the mixture of the coating agent and the oilfield chemical additive onto the uncoated proppants. In embodiments the contacting comprises spraying a liquid medium comprising the oilfield chemical additive onto proppants that are pre-treated with the coating agent. In embodiments the spraying of the liquid medium, comprising the coating agent and/or oilfield chemical additive, is done on-the-fly, and the coated proppants are thereafter mixed with the aqueous liquid in a blender.

In preferred embodiments the coating agent is an organosiloxane, a polysiloxane, or mixtures thereof, optionally mixed with an oil promoter. In preferred embodiments the polysiloxane is a cationic polysiloxane.

In preferred embodiments the coating agent is an amine functionalized polyolefin, optionally mixed with an oil promoter. In preferred embodiments the amine functionalized polyolefin agent is polyisobutylene amine.

In preferred embodiments the coating agent is a polymerizable natural oil optionally mixed with an oil promoter. In preferred embodiments the polymerizable natural oil is tung oil.

In preferred embodiments the oilfield chemical additive is a scale inhibitor. In preferred embodiments the scale inhibitor is 2-Phosphonic-1,2,4-Tricarboxylic Acid (PBTCA).

In embodiments the oilfield chemical additive is a biocide. In preferred embodiments the biocide is tetrakis hydromethyl phosphonium sulfate (THPS).

In another aspect, described herein is a method of controlling the release of a chemical additive into an aqueous fluid, said method comprising coating particulates with a coating agent and the chemical additive, wherein:
a) the coating agent is selected from the group consisting of: organosilanes, organosiloxanes, polysiloxanes, long carbon chain hydrocarbon amines containing no silicon or fluoro-based groups in the molecule, amine functionalized polyolefins and polymerizable natural oils,
b) the chemical additive is selected from the group consisting of: a scale inhibitor, a biocide, and an H₂S scavenger, and
c) the coating of the particulate with the coating agent delays or prolongs the release of the chemical additive from the surface of the particulate as compared to a particulate that is not coated with the coating agent, when the particulate is suspended in the aqueous fluid.

In one embodiment the aqueous fluid is a hydraulic fracturing fluid. In a preferred embodiment the aqueous fluid is a slickwater fracturing fluid.

In one embodiment the coating of the particulates comprises contacting uncoated particulates with a mixture of the coating agent and the chemical additive. In a preferred embodiment the contacting comprises spraying a liquid medium comprising the mixture of the coating agent and the chemical additive onto the uncoated particulates. In another embodiment the contacting comprises mixing uncoated particulates with a liquid medium comprising the mixture of the coating agent and the chemical additive to form coated particulates, and separating the coated particulates from the liquid medium.

In another embodiment the coating of the particulates comprises contacting uncoated particulates with the coating agent to form pretreated particulates, and contacting the pretreated particulates with the chemical additive. In a preferred embodiment the coating comprises spraying a first liquid medium comprising the coating agent onto the uncoated particulates to form the pretreated particulates, and then spraying a second liquid medium comprising the chemical additive onto the pretreated particulates. In one embodiment the contacting of the uncoated particulates comprises mixing the uncoated particulates with a liquid medium comprising the coating agent to form the pretreated particulates, and separating the pretreated particulates from the liquid medium. A liquid medium comprising the chemical additive may be sprayed onto the pretreated particulates.

In a preferred embodiment the coating agent is an organosiloxane, a polysiloxane, or mixtures thereof, optionally mixed with an oil promoter. In preferred embodiments the coating agent is a cationic polysiloxane optionally mixed with an oil promoter.

In a preferred embodiment the coating agent is an amine functionalized polyolefin, optionally mixed with an oil promoter. In preferred embodiments the coating agent is polyisobutylene amine optionally mixed with an oil promoter.

In a preferred embodiment the coating agent is a polymerizable natural oil optionally mixed with an oil promoter. In preferred embodiments the coating agent is tung oil optionally mixed with an oil promoter.

In one embodiment the chemical additive is a scale inhibitor. In preferred embodiments the chemical additive is PBTCA.

In one embodiment the chemical additive is a biocide. In preferred embodiments the chemical additive is THPS.

In another aspect, described herein is a particulate coated with:

a) a coating agent selected from the group consisting of: organosilanes, organosiloxanes, polysiloxanes, long carbon chain hydrocarbon amines containing no silicon or fluoro-based groups in the molecule, amine functionalized polyolefins and polymerizable natural oils; and

b) a chemical additive selected from the group consisting of: a scale inhibitor, a biocide, and an H₂S scavenger,

wherein, when the particulate is suspended in an aqueous fluid the coating agent delays or prolongs the release of the chemical additive from the surface of the particulate as compared to a particulate that is not coated with the coating agent.

In a preferred embodiment the coating agent is an organosiloxane, a polysiloxane, or mixtures thereof, optionally mixed with an oil promoter. In a preferred embodiment the coating agent is a cationic polysiloxane optionally mixed with an oil promoter.

In a preferred embodiment the coating agent is an amine functionalized polyolefin, optionally mixed with an oil promoter. In a preferred embodiment the coating agent is polyisobutylene amine optionally mixed with an oil promoter.

In a preferred embodiment the coating agent is a polymerizable natural oil optionally mixed with an oil promoter. In a preferred embodiment the coating agent is tung oil optionally mixed with an oil promoter.

In a preferred embodiment the chemical additive is a scale inhibitor. In a preferred embodiment the chemical additive is PBTCA.

In a preferred embodiment the chemical additive is a biocide. In a preferred embodiment the chemical additive is THPS.

In another aspect, described herein is a method of hydraulic fracturing, comprising:

a) preparing a hydraulic fracturing fluid that comprises the particulate coated as described above;

b) pumping the hydraulic fracturing fluid into a formation; and

c) fracturing the formation.

In another aspect, described herein is a method of slick water fracturing, comprising:

a) preparing a slick water fracturing fluid that comprises the particulate coated as described above;

b) pumping the slick water fracturing fluid into a formation; and

c) fracturing the formation.

In another aspect, described herein is a method of gravel packing a wellbore, comprising:

a) preparing a gravel packing fluid that comprises the particulate coated as described above; and

b) pumping the gravel packing fluid into the wellbore.

In another aspect, described herein is a method of treating water in a water tank with a scale inhibitor, a biocide, or a H₂S scavenger, comprising:

a) adding the particulate coated as described above to the water in the water tank.

In another aspect, described herein is a method of treating water in a sand bed filtration with a scale inhibitor, a biocide, or a H₂S scavenger, comprising:

a) adding the particulate coated as described above to a sand bed in the sand bed filtration.

### DETAILED DESCRIPTION

For the purposes of understanding the specification and the claims appended hereto, a few terms are defined. Unless defined otherwise, all technical and scientific terms used herein have the same meaning as commonly understood by one of ordinary skill in the art to which embodiments of the disclosure pertain.

The singular forms “a,” “an,” and “the” include plural referents unless the content clearly dictates otherwise. Thus, for example, reference to a composition containing “a compound” includes a composition having two or more compounds.

The term “about” as used herein can allow for a degree of variability in a value or range, for example, within 10%, within 5%, or within 1% of a stated value or of a stated limit of a range.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range such as from 1 to 6 should be considered to have specifically disclosed sub-ranges such as from 1 to 3, from 2 to 4, from 3 to 6 etc., as well as individual numbers within that range, for example, 1, 2, 3, 4, 5, and 6. This applies regardless of the breadth of the range.

In the methods described herein, the steps may be carried out in any order, except when a temporal or operational sequence is explicitly recited. Furthermore, specified steps may be carried out concurrently unless explicit claim language recites that they be carried out separately.

The term “substantially free” refers to a composition or mixture in which a particular compound is present in an amount that has no material effect on the composition or mixture. For example, “substantially free of a viscosifier” means that a viscosifier may be included in the composition or mixture an amount that does not materially affect the viscosity of the composition or mixture. It is within the ability of one skilled in the art with the benefit of this disclosure to determine if and whether an amount of a compound has a material effect on the composition. In embodiments, substantially free may be less than 2 wt. %, less than 1 wt. %, less than 0.5 wt. %, or less than 0.1 wt. %.

The term “fracturing” or “fracturing operation” refers to the process and method of breaking down a geological formation, e.g., the rock formation around a well bore, by pumping fluid at very high pressures, in order to increase production rates from a hydrocarbon reservoir. The fracturing methods disclosed herein use otherwise conventional techniques known in the art. The term “slick water fracturing” refers to a process of fracturing in which a low viscosity fluid (i.e., having a viscosity of less than about 3 cP at 100 sec⁻¹ at surface temperature), is injected into a formation at a flow rate of between about 60 and 100 bpm, to generate narrow fractures with low concentrations of proppant.

The term “fracturing fluid” refers to fluids or slurries used in a formation, during a fracturing operation. The fracturing fluids encompassed herein include fluids comprising aqueous and/or non-aqueous liquids. Aqueous fracturing fluids are preferred, with slick water fracturing fluids being particularly preferred. There are several different types of fracturing fluids known to those of skill in the art, including viscosified water-based fluids, non-viscosified water-based fluids, gelled oil-based fluids, acid-based fluids and foam fluids.

Viscosified water-based fracturing fluids include linear gel fluids which contain a gelling agent like guar, HPG, CMHPG, or xanthan, and have a viscosity of about 10 to about 30 cP at 100 sec⁻¹ at surface temperature, and crosslinked gel fluids which contain the gelling agents used in linear gel fluids plus a crosslinker such as boron (B), zirconium (Zr), titanium (Ti) or aluminum (Al). Cross-linked fluids have a higher viscosity of 100-1000 cP, at 100 sec⁻¹ at surface temperature. Linear gel fluids commonly include medium-size proppant, such as 30/50 size proppant, whereas crosslinked gel fluids commonly include large-size proppant, such as 20/40 size proppant.

A “slick water” fracturing fluid is a non-viscosified water-based fracturing fluid. These fluids are characterized in having a low viscosity, generally less than about 3 cP at 100 sec⁻¹ at surface temperature, generally between about 2 and 3 cP at 100 sec⁻¹ at surface temperature, and a friction-reducing agent in an amount that reduces friction pressure to between about 50% and about 80%, generally between about 60% and about 70%, as compared to fluids that do not have these agents. Common chemistries for friction reduction include polyacrylamide derivatives and copolymers added to the fracturing fluid at low concentrations, for example between about 0.02 wt. % to about 0.05 wt. % of the fluid. Accordingly, slickwater fracturing fluids are commonly free, or substantially free, of viscosifiers such as natural or synthetic polymers and viscoelastic surfactants.

The term “aqueous liquid” as used herein means water, solutions containing water, salt solutions, or water containing an alcohol or other organic solvents. The term “liquid medium” as used herein includes both aqueous and non-aqueous mediums. “Water” as used herein includes freshwater, pond water, sea water, salt water or brine source, brackish water and recycled or re-use water, for example, water recycled from previous or concurrent oil- and gas-field operations.

“Oil” as used herein refers to a neutral, nonpolar chemical substance that is hydrophobic (immiscible with water) and lipophilic (miscible with other oils). Some embodiments of the methods and compositions disclosed herein include an “oil promoter”, which differs from a polymerizable natural oil in being a petrochemical oil, an oil that is derived from petrochemicals, or a silicon oil. Representative non-limiting examples of an oil promoter include hydrocarbon oils such as mineral oil, and silicone oils such as polydimethylsiloxane (PDMS). An oil promoter is added to the compositions and used in the methods herein to promote agglomeration of the particulates or proppants.

The term of “oilfield chemical additive” or “chemical additive”, as used herein means an inorganic or organic scale inhibitor, including a wax inhibitor, a biocide, or an H₂S scavenger. Known inhibitors for preventing inorganic scale formation include lignin amines, inorganic and organic polyphosphates, carboxylic acid copolymers, phosphinic polycarboxylate, polyepoxysuccinic acid, polyaspartates, sodium gluconate and sodium glucoheptonate. Known inhibitors of organic scale formation such as wax scale, include, urea, and fullerenes (aniline/& phenol), and of asphaltene scale formation, alkyl aryl sulfonic acid, alkyl phenol, esters of polyacrylate, polymaleate, polyphosphoric acid, polycarboxylic acid, and N,N dialkylamide of fatty acid.

Exemplary biocides include, but are not limited to, iodopopargyl butyl carbamate, aldehydes, formaldehyde condensates, thazines (e.g., 1,3,5-tris-(2-hydroxyethyl-1,3,5-hexahydrotriazine)), dazomet (e.g., 3,5-dimethyl-2H-1,3,5-thiadiazinane-2-thione), glutaraldehyde (e.g., 1,5 Pentanedial), phenolics, carbonic acid esters, tetrakis(hydroxymethyl)phosphonium sulfate (THPS).

Exemplary H₂S scavengers include, but are not limited to, triazines, aldehydes, and metal oxides.

The fluid compositions described herein can also include other agents, depending on the intended use of the fluid, and provided that these other agents do not adversely affect the composition. For example, polymers may be added to viscosify the fluid, crosslinkers may be added to change a viscous fluid to a pseudoplastic fluid, buffers may be used to control pH, surfactants may be used to lower surface tension, fluid-loss additives may be used to minimize fluid leakoff into a formation, stabilizers may be used to keep the fluid viscous, and breakers may be used to break polymers and crosslink sites.

The term “particulate” as used herein means a solid particle having a size between about 8 and about 200 U.S. mesh. The term particulate, as used herein, includes a proppant. The term “proppant” refers to a particulate which is suspended in fracturing fluid during a fracturing operation, and which serves to keep the formation from closing back down upon itself once the pressure is released. Proppants included in the present disclosure include, but are not limited to, sands, ceramic proppants, glass beads/spheres, synthetic particulates, walnut shells, and any other proppants known in the industry. Of these, sand proppants are particularly preferred. The size of the proppants in the compositions described herein ranges from about 10 to about 100 U.S. mesh, which is from about 150 to about 2,000 μm in diameter. It should be understood that the size distribution of the proppant can be narrow or wide.

The term “particulate coating agent” or “coating agent” as used herein means a chemical compound that is able to coat particulate surfaces, such as sand and ceramic proppants surfaces, in order to make the particulate surface hydrophobic. When an interface exists between a liquid and a solid, the angle between the surface of the liquid and the outline of the contact surface is described as the contact angle θ. There are different methods for measuring contact angle. The contact angle can be measured by a contact angle goniometer using an optical subsystem to capture the profile of a pure liquid on a solid substrate. The angle formed between the liquid-solid interface and the liquid-vapor interface is the contact angle. In the methods and compositions contemplated herein, the contact angle is measured by placing a drop of water on the flat surface of a layer of compacted coated particulate. The flat surface of the layer of compacted coated particulate may be prepared by compacting coated particulate on top of another surface that is flat, for example, glass. The “coating agents” contemplated herein are chemical compounds that cause the contact angle of water on the surface of a coated particulate to be greater than about 60° and in embodiments, greater than about 90°, or between about 60° and about 90°.

For clarity and convenience, coating agents contemplated herein are divided into four groups, A to D, as described below:

Group A) includes organosilanes, organosiloxanes and polysiloxanes modified with different functional groups, including cationic, amphoteric as well as anionic groups, fluorinated silanes, fluorinated siloxanes and fluorinated hydrocarbon compounds. In general, organosilanes are compounds containing silicon to carbon bonds. Polysiloxanes are compounds in which the elements silicon and oxygen alternate in the molecular skeleton, i.e., Si—O—Si bonds are repeated. The simplest polysiloxanes are polydimethylsiloxanes. Polysiloxane compounds can be modified by various organic substitutents having different numbers of carbons, which may contain N, S, or P moieties that impart desired characteristics. For example, cationic polysiloxanes are compounds in which one or more organic cationic groups are attached to the polysiloxane chain, either at the middle or the end or both. The most common organic cationic groups are organic amine derivatives including primary, secondary, tertiary and quaternary amines (for example, quaternary polysiloxanes including, quaternary polysiloxanes including mono- as well as di-quaternary polysiloxanes, amido quaternary polysiloxanes, imidazoline quaternary polysiloxanes and carboxy quaternary polysiloxanes). Similarly, the polysiloxane can be modified by organic amphoteric groups, where one or more organic amphoteric groups are attached to the polysiloxane chain, either at the middle or the end or both, and include betaine polysiloxanes and phosphobetaine polysiloxanes. Among different organosiloxane compounds which are useful for the present compositions and methods are polysiloxanes modified with organic amphoteric or cationic groups including organic betaine polysiloxanes and organic amino or quaternary polysiloxanes as examples. One type of betaine polysiloxane or quaternary polysiloxane is represented by the formula

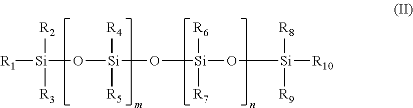

wherein each of the groups R₁ to R₆, and R₈ to R₁₀ represents an alkyl containing 1-6 carbon atoms, typically a methyl group, R₇ represents an organic betaine group for betaine polysiloxane, or an organic quaternary group for quaternary polysiloxane, and have different numbers of carbon atoms, and may contain a hydroxyl group or other functional groups containing N, P or S, and m and n are from 1 to 200. For example, in one type of quaternary polysiloxane R⁷ is represented by the group

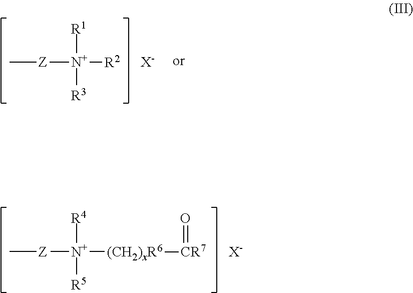

wherein R¹, R², R³ are alkyl groups with 1 to 22 carbon atoms or alkenyl groups with 2 to 22 carbon atoms. R⁴, R⁵, R⁷ are alkyl groups with 1 to 22 carbon atoms or alkenyl groups with 2 to 22 carbon atoms; R⁶ is —O— or the NR⁸ group, R⁸ being an alkyl or hydroxyalkyl group with 1 to 4 carbon atoms or a hydrogen group; Z is a bivalent hydrocarbon group, which may have a hydroxyl group and may be interrupted by an oxygen atom, an amino group or an amide group; x is 2 to 4; The R¹, R², R³, R⁴, R⁵, R⁷ may be the same or different, and X⁻is an inorganic or organic anion including Cl⁻ and CH₃COO⁻. Examples of organic quaternary groups include [R—N⁺(CH₃)₂—CH₂CH(OH)CH₂—O—(CH₂)₃—](CH₃COO⁻), wherein R is an alkyl group containing from 1-22 carbons or an benzyl radical and CH₃COO⁻an anion. Examples of organic betaine groups include —(CH₂)₃—O—CH₂CH(OH)(CH₂)—N⁺(CH₃)₂CH₂COO⁻. Such compounds are commercially available. It should be understood that cationic polysiloxanes include compounds represented by formula (II), wherein R₇ represents other organic amine derivatives including organic primary, secondary and tertiary amines.
Other examples of organo-modified polysiloxanes include di-betaine polysiloxanes and di-quaternary polysiloxanes, which can be represented by the formula

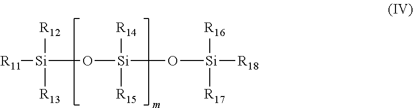

wherein the groups R₁₂ to R₁₇ each represent an alkyl containing 1-6 carbon atoms, typically a methyl group, the R₁₁ and R₁₅ groups represent an organic betaine group for di-betaine polysiloxanes or an organic quaternary group for di-quaternary, and have different numbers of carbon atoms and may contain a hydroxyl group or other functional groups containing N, P or S, and m is from 1 to 200. For example, in one type of di-quaternary polysiloxane R₁₁ and R₁₈ are represented by the group

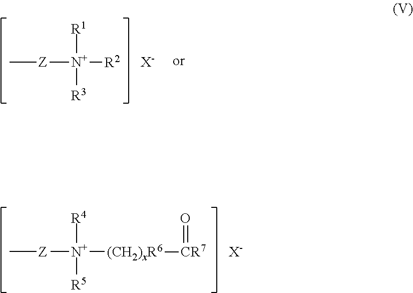

wherein R¹, R², R³, R⁴, R⁵, R⁶, R⁷, Z, X⁻ and x are the same as defined above. Such compounds are commercially available. Quaternium 80 (INCI) is one of the commercial examples.
Similarly, the polysiloxane can be modified by organic anionic groups, where one or more organic anionic groups are attached to the polysiloxane chain, either at the middle or the end or both, including sulfate polysiloxanes, phosphate polysiloxanes, carboxylate polysiloxanes, sulfonate polysiloxanes, thiosulfate polysiloxanes. The organosiloxane compounds also include alkylsiloxanes including hexamethylcyclotrisiloxane, octamethylcyclotetrasiloxane, decamethylcyclopentasiloxane, hexamethyldisiloxane, hexaethyldisiloxane, 1,3-divinyl-1,1,3,3-tetramethyldisiloxane, octamethyltrisiloxane, decamethyltetrasiloxane. The organosilane compounds include alkylchlorosilane, for example methyltrichlorosilane, dimethyldichlorosilane, trimethylchlorosilane, octadecyltrichlorosilane; alkyl-alkoxysilane compounds, for example methyl-, propyl-, isobutyl- and octyltrialkoxysilanes, and fluoro-organosilane compounds, for example, 2-(n-perfluoro-octyl)-ethyltriethoxysilane, and perfluoro-octyldimethyl chlorosilane. Other types of chemical compounds, which are not organosilicon compounds, which can be used to render proppant surfaces hydrophobic are certain fluoro-substituted compounds, for example certain fluoro-organic compounds including cationic fluoro-organic compounds. Further information regarding organosilicon compounds can be found in Silicone Surfactants (Randal M. Hill, 1999) and the references therein, and in U.S. Pat. Nos. 4,046,795; 4,537,595; 4,564,456; 4,689,085; 4,960,845; 5,098,979; 5,149,765; 5,209,775; 5,240,760; 5,256,805; 5,359,104; 6,132,638 and 6,830,811 and Canadian Patent No. 2,213,168, all of which are incorporated herein by reference in their entirety.
Organosilanes can be represented by the formula

RₙSiX₍₄₋ₙ₎ (I)

wherein R is an organic radical having 1-50 carbon atoms that may possess functionality containing N, S, or P moieties that impart desired characteristics, X is a halogen, alkoxy, acyloxy or amine and n has a value of 1-3. Examples of suitable organosilanes include: CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHCH₂Si(OCH₃)₃, (CH₃)₂Si(OCH₃)₂, (CH₂═CH)Si(CH₃)₂Cl, (CH₃)₂Si(OCH₂CH₃)₂, (CH₃)₂Si(OCH₂CH₂CH₃)₂, (CH₃)₂Si[O(CH₂)₃CH₃]₂, (CH₃CH₂)₂Si(OCH₂CH₃)₂, (C₆H₅)₂Si(OCH₃)₂, (C₆H₅CH₂)₂Si(OCH₃)₂, (C₆H₅)₂Si(OCH₂CH₃)₂, (CH₂═CH)₂Si(OCH₃)₂, (CH₂═CHCH₂)₂Si(OCH₃)₂, (CH₃)₃SiOCH₃, CH₃HSi(OCH₃)₂, (CH₃)₂HSi(OCH₃), CH₃Si(OCH₂CH₂CH₃)₃, CH₂═CHCH₂Si(OCH₂CH₂OCH₃)₃, (C₆H₅)₂Si(OCH₂CH₂OCH₃)₂, (CH₃)₂Si(OCH₂CH₂OCH₃)₂, (CH₂═CH)₂Si(OCH₂CH₂OCH₃)₂, (CH₂═CHCH₂)₂Si(OCH₂CH₂OCH₃)₂, (C₆H₅)₂Si(OCH₂CH₂OCH₃)₂, CH₃Si(CH₃COO)₃, 3-aminotriethoxysilane, methyldiethylchlorosilane, butyltrichlorosilane, diphenyldichlorosilane, vinyltrichlorosilane, methyltrimethoxysilane, vinyltriethoxysilane, vinyltris(methoxyethoxy)silane, methacryloxypropyltrimethoxysilane, glycidoxypropyltrimethoxysilane, aminopropyltriethoxysilane, divinyldi-2-methoxysilane, ethyltributoxysilane, isobutyltrimethoxysilane, hexyltrimethoxysilane, n-octyltriethoxysilane, dihexyldimethoxysilane, octadecyltrichlorosilane, octadecyltrimethoxysilane, octadecyldimethylchlorosilane, octadecyldimethylmethoxysilane and quaternary ammonium silanes including 3-(trimethoxysilyl)propyldimethyloctadecyl ammonium chloride, 3-(trimethoxysilyl)propyldimethyloctadecyl ammonium bromide, 3-(trimethylethoxysilylpropyl)didecylmethyl ammonium chloride, triethoxysilyl soyapropyl dimonium chloride, 3-(trimethylethoxysilylpropyl)didecylmethyl ammonium bromide, 3-(trimethylethoxysilylpropyl)didecylmethyl ammonium bromide, triethoxysilyl soyapropyl dimonium bromide, (CH₃O)₃Si(CH₂)₃P⁺(C₆H₅)₃Cl, (CH₃O)₃Si(CH₂)₃P⁺(C₆H₅)₃Br⁻, (CH₃O)₃Si(CH₂)₃P⁺(CH₃)₃Cl⁻, (CH₃O)₃Si(CH₂)₃P⁺(C₆H₁₃)₃Cl⁻, (CH₃O)₃Si(CH₂)₃N+(CH₃)₂C₄H₉Cl, (CH₃O)₃Si(CH₂)₃N+(CH₃)₂CH₂C₆H₅Cl⁻, (CH₃O)₃Si(CH₂)₃N+(CH₃)₂CH₂CH₂OHCl⁻, (CH₃O)₃Si(CH₂)₃N+(C₂H₅)₃Cl⁻, (C₂H₅O)₃Si(CH₂)₃N+(CH₃)₂C₁₈H₃₇Cl−. It is well known that some silanes, for example, alkoxy silanes, undergo hydrolysis in aqueous medium before reacting with hydroxyl groups (—OH) on the particulate surfaces, for example, sand surfaces. It is noted that further included in the term of organosilanes or organosiloxanes are silicone-modified polyolefin or polyacrylic and their respective copolymers, where silane such as hydrolysable silane including alkoxyl-silane group, or siloxane groups including cationic siloxane group, are attached to the polymer chain either at middle or end or both. Examples of silane-modified hydrophobic polymers, by way of illustration only, include: (a) silane-modified polyolefin including silane-modified polybutyl, silane-modified polyisobutylene, silane-modified polyethylenes, silane-modified olefin copolymer and silane-modified polypropylenes and the copolymers; (b) silane-modified styrene polymers; (c) silane-modified vinyl polymers; (d) silane-modified acrylate polymers including silane-modified poly(t-butyl methacrylate), poly(t-butylaminoethyl methacrylate); and (e) silane-modified polyesters. Especially preferred are silane-modified polyolefins including homo and copolymers such as polyethylene and polypropylene, and copolymers of ethylene-propylene, ethylene-butene, ethylene-hexene, ethylene-vinyl-acetate, vinyl-acetate, ethylene-methyl-acrylate, ethylene-ethyl-acrylate and ethylene-butyl-acrylate. These silane-modified polymers and copolymers are known and have been disclosed, for example, in various patents including U.S. Pat. Nos. 3,729,438; 3,814,716; 6,455,637; 6,863,985 and 8,476,375, which are incorporated herein by reference in their entirety. Silane-modified polymers or copolymers, prepared as an aqueous dispersion, are disclosed, for example, in U.S. Pat. Nos. 3,729,438; 3,814,716 and 6,863,985, which are incorporated herein by reference in their entirety, and are especially preferred for use in the methods and compositions described herein.
Group B) includes long carbon chain hydrocarbon amines containing no silicon or fluoro-based groups in the molecules. Such compounds contain at least fourteen and preferably at least sixteen carbon atoms, which can readily adsorb on sand surface, and include simple primary, secondary, tertiary amines, primary ether amines, di-amines, polyamines, ether diamines, stearyl amines, tallow amines, condensates of amine or alkanolamine with fatty acid or fatty acid ester, condensates of hydroxyethylendiamines. Examples include the condensate of diethylenetetraamine and tallow oil fatty acid, tetradecyloxypropyl amine, octadecyloxypropyl amine, hexadecyloxypropyl amine, hexadecyl-1,3-propanediamine, tallow-1,3-propanediamine, hexadecyl amine, tallow amine, soyaalkylamine, erucyl amine, hydrogenated erucyl amine, ethoxylated erucyl amine, rapeseed amine, hydrogenated rapeseed amine, ethoxylated rapeseed amine, ethoxylated oleylamine, hydrogenated oleylamine, ethoxylated hexadecyl amine, octadecylamine, ethoxylated octadecylamine, ditallowamine, hydrogenated soyaalkylamine, amine, hydrogenated tallow amine, di-octadecylamine, ethoxylated (2) tallowalkylamine, for example Ethomeen T/12 or ethoxylated (2) soyaalkylamine, for example, Ethomeen S/12, or oleyl amine, for example Armenn OL, or di-cocoalkalamine, for example Armeen 2C from Akzo Nobel Inc., and the condensate of an excess of fatty acids with diethanolamine;
Group C) includes amine functionalized polyolefins, which is a class of polymers or copolymers synthesized from simple olefin as a monomer and includes polybutyl amine, polyisobutylene amine, polyisobutylene succinimide, amine functionalized polyethylenes, amine-terminated olefin copolymer, amine functionalized polypropylenes and combinations thereof; and
Group D) includes polymerizable natural oils such as tung oil or linseed oil which can coat and polymerise on particulate surfaces. A polymerizable natural oil, as used herein, is an oil that is extracted from a plant source, and that comprises unsaturated carbon-carbon double bonds that can be polymerized in the presence of oxygen.

The compounds of Groups A), B) C) and D) are further described and exemplified in the following references, all of which are incorporated herein by reference in their entirety: U.S. Pat. Nos. 7,723,274, 8,236,738, 8,105,986; US Publication nos. 20100256024, 20120322697, 2012267112, 2012067584, 20150252254, 20150307772, 20160017213; 20160222282; WO2006/116868, WO2007/033489 and Canadian patent no. 2,735,428.

The methods described herein contemplate coating particulates with the coating agent and the chemical additive, to generate coated particulates that are subsequently used in a number of different applications, including oilfield applications. Without being limited to theory, Applicant believes that making the surface of the particulate hydrophobic with the coating agent enables the particulate to retain the chemical additive on its surface for a longer period of time than if the surface was not rendered hydrophobic. The application of the coating agent to the particulate surface therefore alters the surface of the particulate, such that it controls the release of the chemical additive into surrounding fluid, by delaying or prolonging its release from the surface, as compared to a particulate that is not coated with the coating agent.

Applicant contemplates several embodiments of the method for coating particulates with the coating agent and the chemical additive, so as to embed the additive into the coating agent on the particulate surface, and/or to attach it thereto, thus delaying or prolonging its release from the surface of the particulate. As used herein, a “coated particulate” is a particulate that has been coated with both the coating agent and the chemical additive.

In one approach, particulates such as proppant may be coated by contacting the particulates (for example by spraying or mixing them) with a liquid medium containing both the coating agent, for example, an amino-polysiloxane, and the chemical additive, for example, a scale inhibitor or a wax inhibitor. The coated particulates may then be dried and stored for later use, or used directly. The preferred liquid medium is alcohol or alcohol containing an amount of water.

Alternatively, particulates such as proppant may be coated by contacting the particulates (for example by spraying or mixing them) with a liquid medium containing the coating agent, for example, an amino-polysiloxane, an oil promoter and the chemical additive, for example a scale inhibitor. The coated particulates may then be dried and stored for later use, or used directly. The preferred liquid medium is alcohol or alcohol containing an amount of water.

In a hydraulic fracturing operation, a preferred method of coating proppant with a liquid medium comprising the coating agent and chemical additive is to apply the liquid medium, preferably by spraying, onto the proppants “on-the-fly”. “On-the-fly” means that a flowing stream is continuously introduced into another flowing stream so that the streams are combined and mixed while continuing to flow as a single stream. In the instant disclosure, on-the-fly refers to the application of liquid medium comprising compounds to the surface of the proppants when the proppants are being used in a hydraulic fracturing operation, and before the proppants are added to the hydraulic fracturing fluid. An apparatus for treating the proppants on-the-fly has been described in Canadian patent application No. 2,877,025 which is incorporated herein by reference in its entirety.

Alternatively again, particulates such as proppants can be pretreated with the coating agent before the chemical additive is applied to the surface. That is, particulates may be first treated by contacting them with a liquid medium containing the coating agent, for example, an amino-polysiloxane (e.g., by spraying or mixing them with the liquid medium). These pretreated particulates may then be dried and stored to be treated later with the chemical additive, or they may be treated with the chemical additive directly afterwards. The chemical additive may be applied to the surface of the pretreated particulates, for example, by contacting the pretreated particulates with a liquid medium that contains the chemical additive (e.g., by spraying them or mixing them, with the liquid medium). The coated particulates may then be dried and stored for later use, or used directly. The preferred liquid medium is alcohol or alcohol containing an amount of water.

In a hydraulic fracturing operation, the chemical additive, for example, a wax inhibitor, or a biocide, may be sprayed onto the pretreated proppants on-the-fly, before the coated proppants are added into the fracturing fluid. Alternatively again, an oil promoter such as a mineral oil can be added to the liquid medium used to treat the proppants with the coating agent and/or chemical additive.

Contemplated herein are embodiments in which more than one chemical additive is applied to the surface of the particulates. For example, a wax inhibitor, an inorganic scale inhibitor and a biocide can be applied onto the same particulate surface, for example a sand surface, using the methods described in this application. Applicant also contemplates herein the use of more than one coating agent to coat the particulates.

The application of the coating agent and/or chemical additive to the surface of the particulate may, in some embodiments, for example when silane-modified polyolefin is used as a coating agent, be accompanied by the use of heat, which speeds up the drying of the surface of the particulate. For example, in spray applications in a sand plant, this heat may be provided by warm sands freshly coming out a heated drier.

A gas such as air, nitrogen, carbon dioxide, natural gas, can be mixed into the fracturing fluid. Preferred for use herein are air and nitrogen.

In a fracturing operation proppants, either pre-treated with the coating agent, or untreated prior to the operation, may be treated on-the-fly with a liquid medium containing the chemical additive or a mixture of the coating agent and chemical additive respectively, and mixed with an aqueous fracturing fluid in a blender immediately before or as the mixture is being pumped into the formation. Alternatively, proppants that are already coated with both the coating agent and the chemical additive may be used. A gas such as nitrogen may additionally be mixed into the mixture at the discharge side of the blender, or at a point close to the wellhead. The gas may be used at different concentrations, preferably at 5-20 vol. % of the total volume of the mixture.

In embodiments the coating agent and/or chemical additive are dissolved or dispersed in a liquid medium at a concentration of between about 0.5 wt. % to about 10 wt. %, preferably from about 1.0 wt. % to about 5.0 wt. %. The liquid medium is then applied to the particulate, including proppant, at an amount between about 10 L/Tonne and about 0.1 L/Tonne of particulate/proppant. In preferred embodiments this amount is between about 5 L/Tonne and about 0.5 L/Tonne.

In addition to the hydraulic fracturing operations, the coated particulates such as sands can also be used in other oilfield applications including gravel packing. In this application coated sands, coated with a coating agent and a biocide, wax inhibitor, scale inhibitor or all three, may be pumped into a wellbore as a gravel pack, to prevent formation sands from migrating into the wellbore, while at the same time acting as a chemical source for treating the fluids, such as oil or water, flowing through the gravel pack.

Alternatively the coated particulates such as sands, coated with a coating agent and a biocide, scale inhibitor or both, can be added into a water source, for example, a water tank, to provide long-term inhibition for scale, or bacteria or both. It is particularly applicable to treating the fracturing water either prior to being pumped into the formation or after flowing back from the formation after the operation. In these applications different particulates with wide range of size, for example, from about 8 to about 200 U.S. mesh, can be used.

### EXAMPLES

Having thus described the composition and method herein, specific embodiments will now be exemplified.

### Example 1

[Inorganic Scale Inhibitor 2-Phosphonic-1,2,4-Tricarboxylic Acid (PBTCA) with No Coating, as Control]

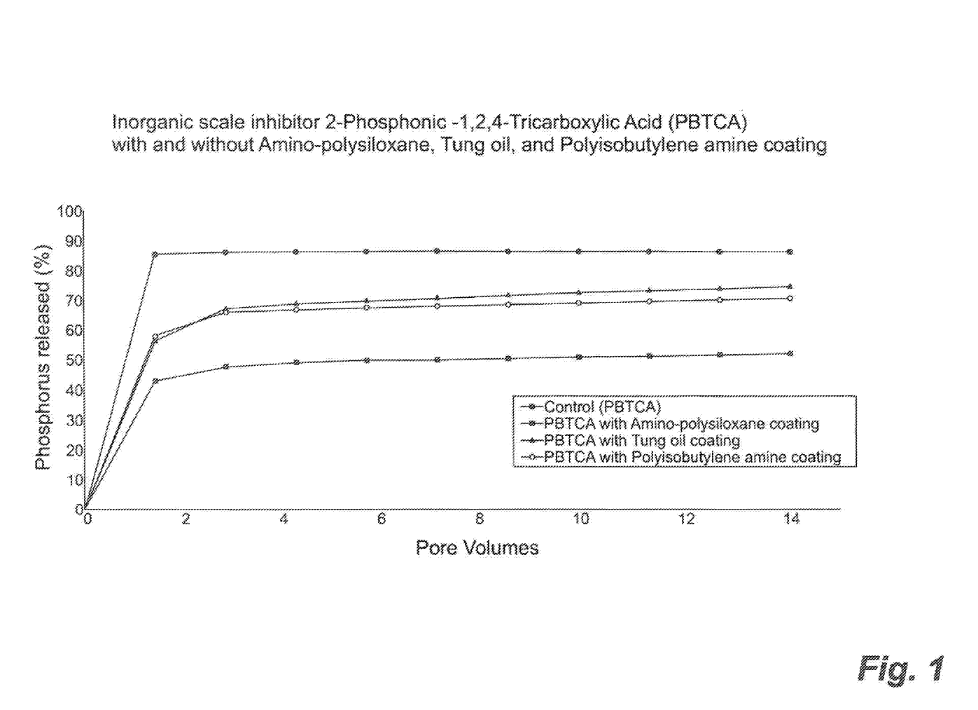

0.15 mL of PBTCA 62% aqueous solution was added to 150 gram of 20/40 US mesh sand and stirred. Then the sand was heated in an oven at 70° C. for 2 hours, after which it was packed in a glass column and tap water was flushed through by hydrostatic pressure. The effluent was collected and phosphorus concentration was determined by using Inductively Coupled Plasma Optical Emission Spectroscopy (ICP-OES). It was found that after 14 pore volumes of water, the amount of phosphorus on the proppant pack was depleted to 2 mg, from the initial 14.53 mg of phosphorus added, which represents 126.7 mg of the whole PBTCA molecule; this implies that 13.7% of the initial phosphorus remains available on the proppant pack for further release. Please refer to FIG. 1.

### Example 1A

[Inorganic Scale Inhibitor 2-Phosphonic-1,2,4-Tricarboxylic Acid (PBTCA) with Amino-Polysiloxane Coating]

1.5 mL of 10 wt. % amino-polysiloxane (dimethyl, methyl(3-aminopropyl) siloxane, 3-aminopropylethoxymethylsiloxy-terminated) in mineral oil was mixed with 150 gram of 20/40 US mesh sand. The mixture was thoroughly stirred and then 0.15 mL of PBTCA 62% aqueous solution was added and it was stirred again. Then the coated sand was heated in an oven at 70° C. for 2 hours, after which it was packed in a glass column and tap water was flushed through by hydrostatic pressure. The effluent was collected and phosphorus concentration was determined by using Inductively Coupled Plasma Optical Emission Spectroscopy (ICP-OES). It was found that after 14 pore volumes of water, the amount of phosphorus on the proppant pack was depleted to 7 mg, from the initial 14.53 mg of phosphorus added, which represents 126.7 mg of the whole PBTCA molecule; this implies that 48% of the initial phosphorus remains available on the proppant pack for further release. Please refer to FIG. 1.

### Example 1B

[Inorganic Scale Inhibitor 2-Phosphonic-1,2,4-Tricarboxylic Acid (PBTCA) with Tung Oil Coating]

1.5 mL of 10 wt. % Tung Oil in mineral oil was mixed with 150 gram of 20/40 US mesh sand. The mixture was thoroughly stirred and then 0.15 mL of PBTCA 62% aqueous solution was added and stirred again. Then the coated sand was heated in an oven at 70° C. for 2 hours, after which it was packed in a glass column and tap water was flushed through by hydrostatic pressure. The effluent was collected and phosphorus concentration was determined by using Inductively Coupled Plasma Optical Emission Spectroscopy (ICP-OES). It was found that after 14 pore volumes of water, the amount of phosphorus on the proppant pack was depleted to 3.73 mg, from the initial 14.53 mg of phosphorus added, which represents 126.7 mg of the whole PBTCA molecule; this implies that 25.7% of the initial phosphorus remains available on the proppant pack for further release. Please refer to FIG. 1.

### Example 10

[Inorganic Scale Inhibitor 2-Phosphonic-1,2,4-Tricarboxylic Acid (PBTCA) with Polyisobutylene Amine Coating]

1.5 mL of 10 wt. % Polyisobutylene Amine (BASF RD200315) in mineral oil was mixed with 150 gram of 20/40 US mesh sand. The mixture was thoroughly stirred and then 0.15 mL of PBTCA 62% aqueous solution was added and stirred again. Then the coated sand was heated in an oven at 70° C. for 2 hours, after which it was packed in a glass column and tap water was flushed through by hydrostatic pressure. The effluent was collected and phosphorus concentration was determined by using Inductively Coupled Plasma Optical Emission Spectroscopy (ICP-OES). It was found that after 14 pore volumes of water, the amount of phosphorus on the proppant pack was depleted to 4.32 mg, from the initial 14.53 mg of phosphorus added, which represents 126.7 mg of the whole PBTCA molecule; this implies that 29.7% of the initial phosphorus remains available on the proppant pack for further release. Please refer to FIG. 1.

### Example 2

[Biocide Tetrakis Hydromethyl Phosphonium Sulfate (THPS) with No Coating, as Control]

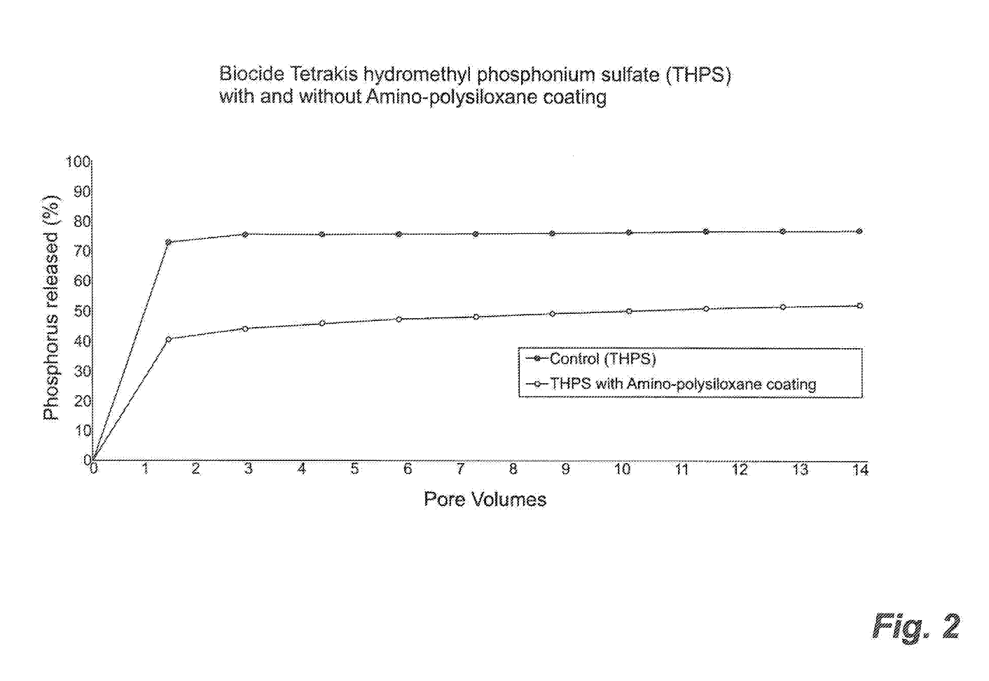

0.15 mL of THPS was added to 150 gram of 20/40 US mesh sand and stirred. Then the sand was heated in an oven at 70° C. for 2 hours, after which it was packed in a glass column and tap water was flushed through by hydrostatic pressure. The effluent was collected and phosphorus concentration was determined by using Inductively Coupled Plasma Optical Emission Spectroscopy (ICP-OES). It was found that after 14 pore volumes of water, the amount of phosphorus on the proppant pack was depleted to 9.9 mg, from the initial 31.6 mg of phosphorus added, which represents 207 mg of the whole THPS molecule; this implies that 31.3% of the initial phosphorus remains available on the proppant pack for further release. Please refer to FIG. 2.

### Example 2A

[Biocide Tetrakis Hydromethyl Phosphonium Sulfate (THPS) with Amino-Polysiloxane Coating]

1.5 mL of 10 wt. % amino-polysiloxane (dimethyl, methyl(3-aminopropyl) siloxane, 3-aminopropylethoxymethylsiloxy-terminated) in mineral oil was mixed with 150 gram of 20/40 US mesh sand. The mixture was thoroughly stirred and then 0.15 mL of THPS solution was added and stirred again. Then the coated sand was heated in an oven at 70° C. for 2 hours, after which it was packed in a glass column and tap water was flushed through by hydrostatic pressure. The effluent was collected and phosphorus concentration was determined by using Inductively Coupled Plasma Optical Emission Spectroscopy (ICP-OES). It was found that after 14 pore volumes of water, the amount of phosphorus on the proppant pack was depleted to 16.1 mg, from the initial 31.6 mg of phosphorus added, which represents 207 mg of the whole THPS molecule; this implies that 51.1% of the initial phosphorus remains available on the proppant pack for further release. Please refer to FIG. 2.

1. A method of hydraulic fracturing of a formation, comprising:
a) preparing a hydraulic fracturing fluid by mixing coated proppants with an aqueous liquid:
wherein the coated proppants are coated with:
i) a coating agent selected from the group consisting of: organosilanes, organosiloxanes, polysiloxanes, long carbon chain hydrocarbon amines containing no silicon or fluoro-based groups in the molecule, amine functionalized polyolefins and polymerizable natural oils; and
ii) an oilfield chemical additive selected from the group consisting of: a scale inhibitor, a biocide, and an H₂S scavenger; and
b) pumping the hydraulic fracturing fluid into the formation.

2. The method of claim 1, wherein the hydraulic fracturing fluid is a slick water fracturing fluid.

3. The method of claim 1 further comprising preparing the coated proppants by contacting uncoated proppants with a mixture of the coating agent and the oilfield chemical additive.

4. The method of claim 1 further comprising preparing the coated proppants by contacting pre-treated proppants that have been coated with the coating agent, with the oilfield chemical additive.

5. The method of claim 3 wherein the contacting comprises spraying a liquid medium comprising the mixture of the coating agent and the oilfield chemical additive onto the uncoated proppants.

6. The method of claim 4 wherein the contacting comprises spraying a liquid medium comprising the oilfield chemical additive onto the pre-treated proppants.

7. The method of claim 5 wherein the spraying of the liquid medium is done on-the-fly, and the coated proppants are thereafter mixed with the aqueous liquid in a blender.

8. The method of claim 6 wherein the spraying of the liquid medium is done on-the-fly, and the coated proppants are thereafter mixed with the aqueous liquid in a blender.

9. The method of claim 1, wherein the coating agent is an organosiloxane, a polysiloxane, or mixtures thereof, optionally mixed with an oil promoter.

10. The method of claim 9, wherein the coating agent is a cationic polysiloxane optionally mixed with an oil promoter.

11. The method of claim 9, wherein the coating agent is an amine functionalized polyolefin, optionally mixed with an oil promoter.

12. The method of claim 9, wherein the coating agent is polyisobutylene amine optionally mixed with an oil promoter.

13. The method of claim 9, wherein the coating agent is a polymerizable natural oil optionally mixed with an oil promoter.

14. The method of claim 9, wherein the coating agent is tung oil optionally mixed with an oil promoter.

15. The method of claim 1, wherein the oilfield chemical additive is a scale inhibitor.

16. The method of claim 10, wherein the oilfield chemical additive is a scale inhibitor.

17. The method of claim 1, wherein the oilfield chemical additive is 2-Phosphonic-1,2,4-Tricarboxylic Acid (PBTCA).

18. The method of claim 10, wherein the oilfield chemical additive is PBTCA.

19. The method of claim 1, wherein the oilfield chemical additive is a biocide.

20. The method of claim 10, wherein the oilfield chemical additive is a biocide.

21. The method of claim 1 wherein the wherein the oilfield chemical additive is tetrakis hydromethyl phosphonium sulfate (THPS).

22. The method of claim 10, wherein the oilfield chemical additive is THPS.
